(19) United States
(12) Patent Application Publication
(10) Pub. No.: US 2007/0072476 A1
(43) Pub. Date: Mar. 29, 2007

(54) Universal serial bus hub

(76) Inventor: Henry Milan, Rochester, MI (US)

Correspondence Address: BUTZEL LONG, STONERIDGE WEST, 41000 WOODWARD AVENUE, BLOOMFIELD HILLS, MI, 48304, US

(21) Appl. No.: 11/509,233

(22) Filed: Aug. 24, 2006

Related U.S. Application Data
(60) Provisional application No. 60/710,756, filed on Aug. 24, 2005.

(51) Int. Cl. H01R 13/62

(52) U.S. Cl. 439/373

(57) ABSTRACT

A portable USB hub provides at least one conventional female USB connector and at least one conventional standard male electrical connector for plugging the hub into a corresponding outlet. The hub converts the AC electrical power provided through the outlet connection into lower voltage DC power supplying the USB circuitry. The USB hub is provided with interchangeable male plugs for use in different geographic areas. The USB hub may be plugged into an outlet strip having surge protection that is transferred to the connected device. Alternatively, the USB hub may be plugged into a wall outlet, relying on the surge protection provided with the connected device.

### RELATED CASES

The present application claims the benefit of U.S. Provisional Patent Application Ser. No. 60/710,756 filed on Aug. 24, 2005.

### BACKGROUND OF THE INVENTION

The present invention relates generally to universal serial bus (USB) hubs used with surge protected outlet strips.

The following patents provide background in the field of USB hubs and outlet strips:

U.S. Pat. No. 6,716,047 entitled “Modular Stackable Component System Including Universal Serial Bus Hub”;

U.S. Pat. No. 6,726,509 entitled “Stackable Power Supply System”; and

U.S. Pat. No. 6,755,676 entitled “Modular Outlet Strip”, all of which are incorporated herein by reference.

### SUMMARY OF THE INVENTION

The present invention provides a USB hub with interchangeable plugs for use in the geographic areas, but not limited to Europe, Australia, USA, and the United Kingdom. The portable USB hub provides at least one conventional female USB connector and at least one conventional standard male electrical connector for plugging the hub into a corresponding outlet. The hub includes a transformer that converts the AC electrical power provided through the outlet connection into lower voltage DC power supplying the USB circuitry. The USB hub is provided with interchangeable male plugs for use throughout the known world which may be electrically connected through a surge protection module or, alternatively, may include a surge protector within the housing itself, providing surge protection in addition to the low voltage DC power supply.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1a is a perspective view of a USB hub in accordance with the present invention;

FIG. 1b is a side elevation view of the USB hub of FIG. 1a;

FIG. 2 is a perspective view of an outlet strip used in conjunction with the USB hub of FIG. 1a;

FIGS. 3a-3c are fragmentary perspective views of the USB hub of FIG. 1a shown installed on the outlet strip of FIG. 2;

FIGS. 4a and 4b are perspective rear and front views, respectively, of the housing of the USB hub of FIG. 1a;

FIG. 5 is a perspective view showing a bottom side of an alternate embodiment USB hub according to the present invention;

FIG. 6 is a fragmentary perspective view of an alternate embodiment outlet strip used in conjunction with the USB hub of FIG. 5;

FIGS. 7a and 7b are fragmentary perspective views of the USB hub of FIG. 5 installed on the outlet strip of FIG. 6;

FIG. 7c is a fragmentary side elevation view of the USB hub and the outlet strip shown in FIGS. 7a and 7b;

FIG. 8 is an electrical schematic of the USB hub and the power strip in accordance with the present invention; and

FIGS. 9a-d are perspective rear and front views, respectively, of an alternate embodiment USB hub according to the present invention.

### DESCRIPTION OF THE PREFERRED EMBODIMENT

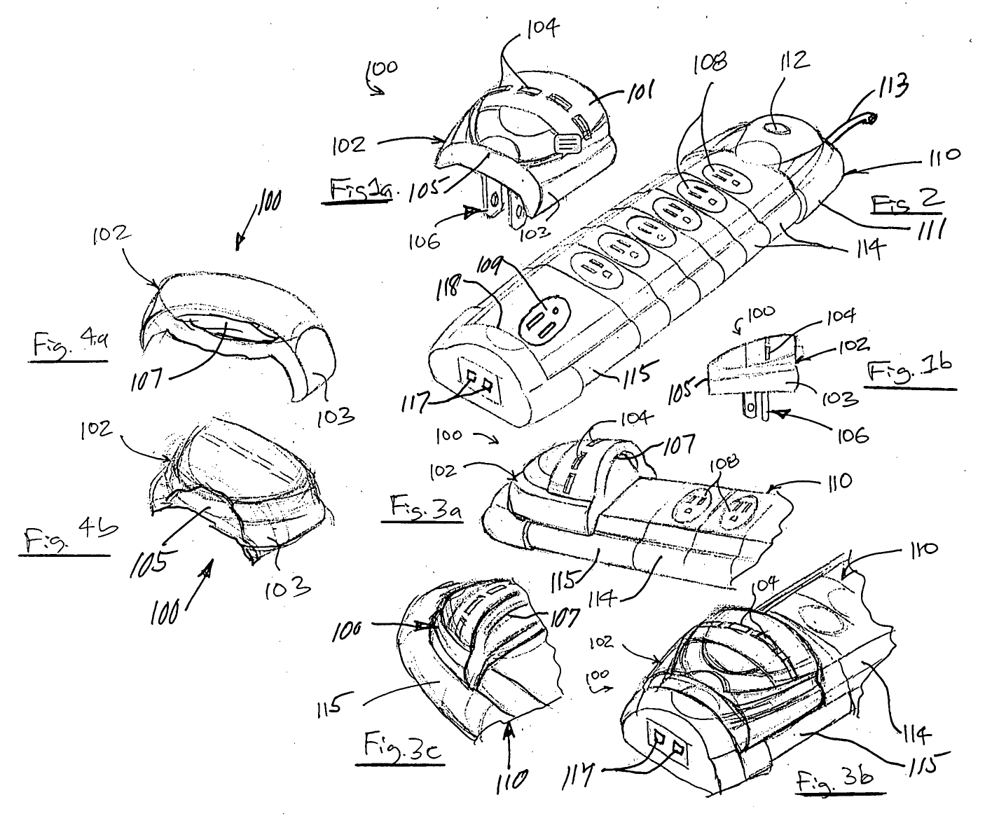

Referring now to FIGS. 1a and 1b, a USB hub in accordance with a first embodiment of the present invention is indicated generally at 100. The USB hub 100 includes a housing 102 made from a suitable material such as molded plastic. An upper rounded surface 101 of the housing 102 has a plurality of apertures formed therein each of which has a conventional female USB connector 104 mounted therein. The connectors 104 are arranged in a line extending across the surface 101 from side to side. The USB connectors 104 are adapted to receive corresponding male USB connectors (not shown) for connecting to various computer peripheral devices including, but not limited to, flash drives, external hard drives, digital cameras, and the like. The USB hub 100 is provided with electrical power through a standard male three prong electrical connector 106 that extends from a lower surface of the housing 102 for connection to a source of electrical power at a standard receptacle.

There is shown in FIG. 2 a modular outlet strip 110 similar in operation to the modular outlet strip shown in the U.S. Pat. No. 6,755,676. The outlet strip 110 includes a power distribution module 111, having an on/off switch 112 and a power cord 113, connected to a plurality of receptacle modules 114, connected to a surge protection module 115. Each of the receptacle modules 114 includes at least one electrical power receptacle 108 electrically connected through the switch 112 for providing line current when the power cord 113 is plugged into a wall receptacle (not shown) connected to a power circuit in a building. The surge protection module 115 also includes an electrical power receptacle 109 turned 90° from the receptacles 108 to mate with the connector 106 on the USB hub 100. One or more pairs of electrical signal connectors 117, such as standard co-axial connectors, RJ11 connectors and RJ45 connectors, can be provided in an end surface of the module 115.

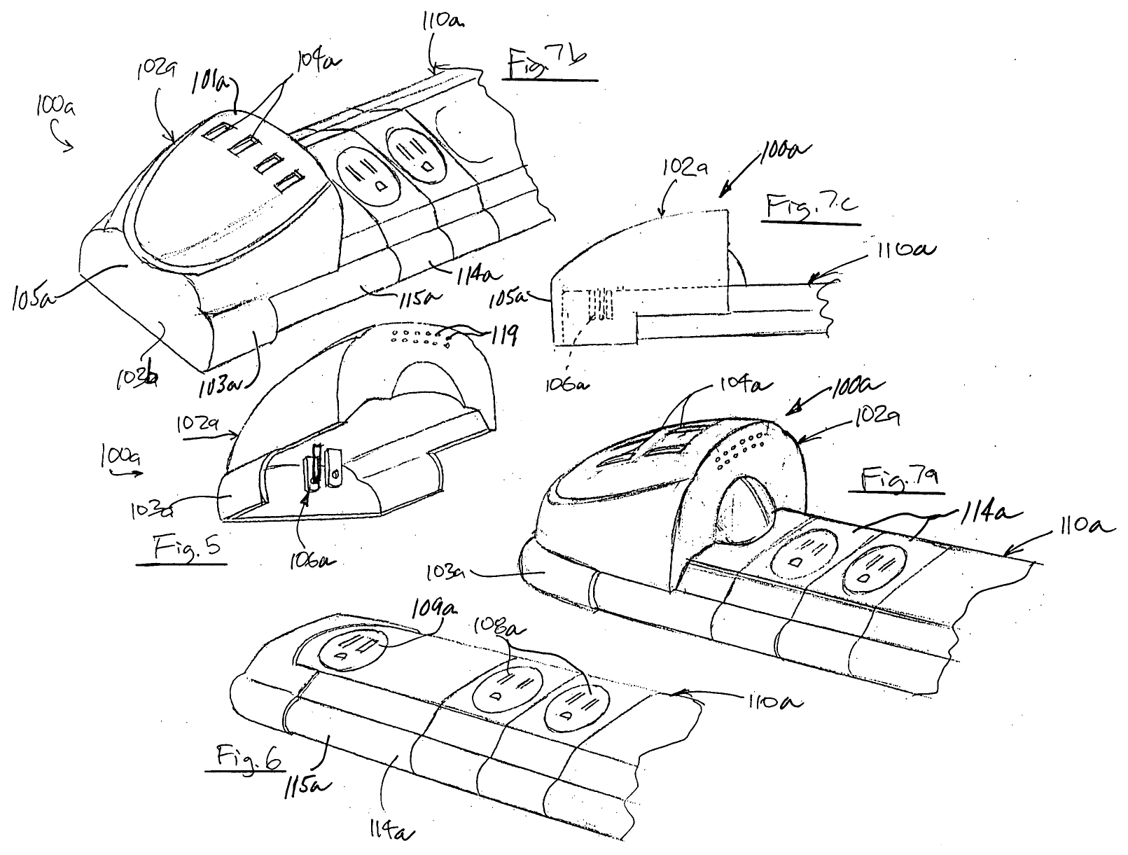

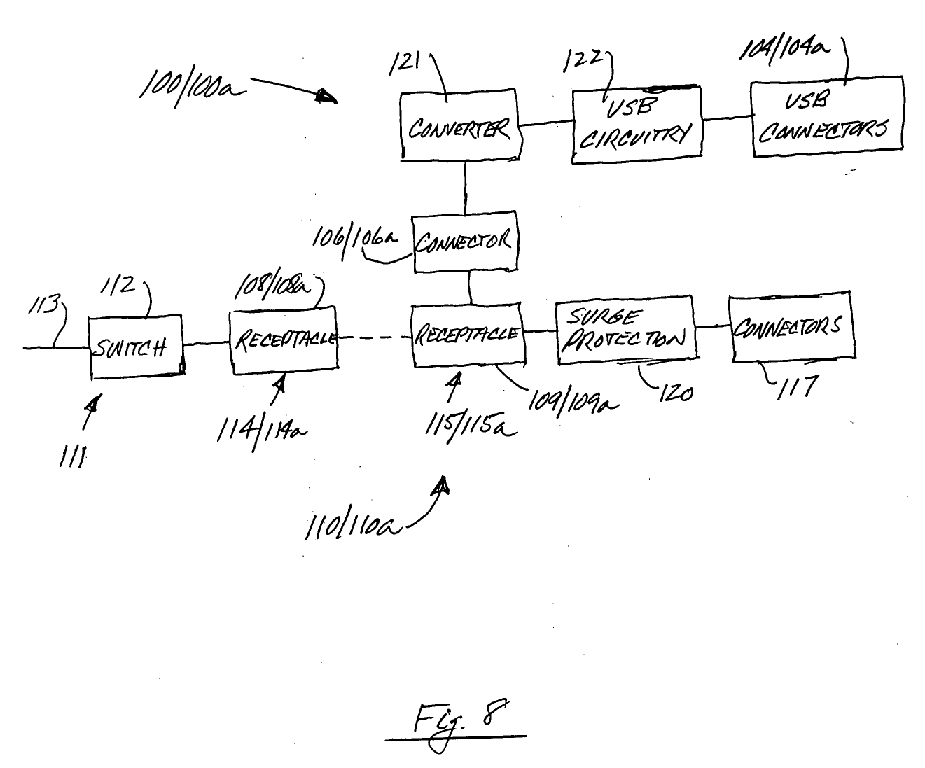

The housing 102 can include wing portions 103 extending downwardly therefrom for cooperating with an exterior surface of the surge protection module 115. Preferably, the housing 102 and/or the wing portions 103 are shaped to conform to exterior surface of the module 115 so that it provides an aesthetically pleasing and uniform appearance, such as that shown in FIGS. 3a, 3b, and 3c. For example, the housing 102 has a planar vertical surface 105 at the front thereof (shown in FIGS. 1a, 1b and 4b) that abuts a planar vertical surface 118 of the module 115. The housing 102 also has a recess 107 (shown in FIGS. 3a, 3c and 4a) formed in a rear surface thereof that provides a convenient finger grip for removing the hub 100 from the outlet strip 102.

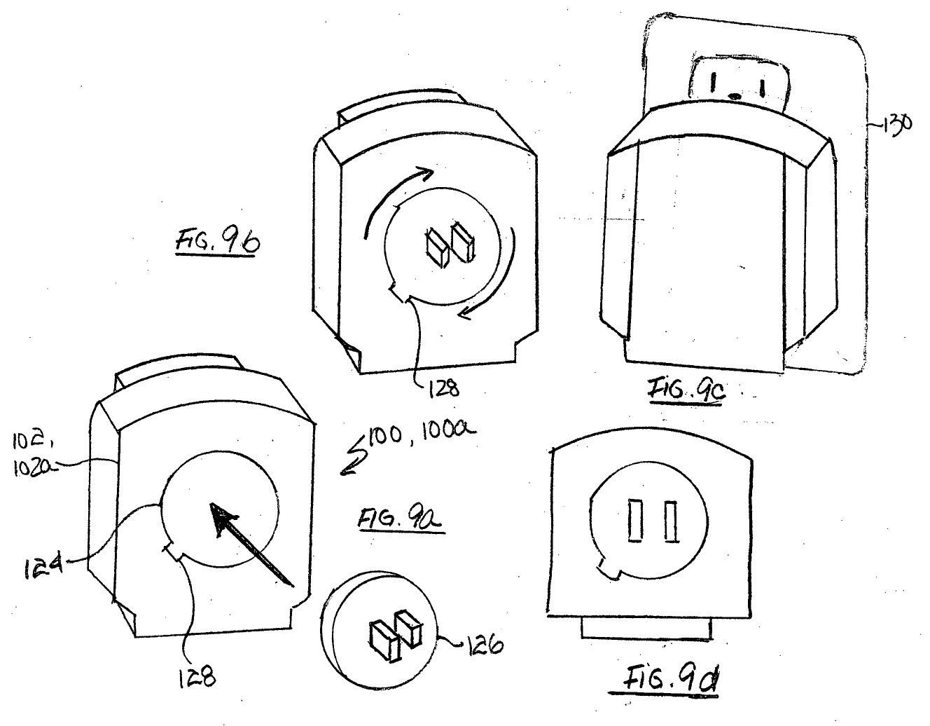

An alternative second embodiment of the USB hub in accordance with the present invention is indicated generally at 100a in FIGS. 5-7c. Components similar to those of the first embodiment are identified with the same reference numerals with an “a” suffix added. The USB hub 100a has a housing 102a that has a different ornamental appearance than the housing 102. Wing portions 103a extend forwardly and include a generally planar vertical front surface 103b such the free end of the surge protection module 115, best seen in FIG. 7b, is covered. Also, a plurality of USB connectors 104a have been rotated 90°, as have an electrical connector 106a and a cooperating electrical receptacle 109a. A plurality of ventilation apertures 119 is formed through a rear wall of the housing 102a to cool the circuitry inside during operation.

Referring now to FIG. 8, an electrical schematic of the USB hubs 100/100a and the outlet strips 110/110a is shown. The power cord 113 is connected through the switch 112 to the receptacle modules 114/114a and the surge protection module 115/115a. The surge protection module 115/115a includes the receptacle 109/109a and the connectors 117 (first embodiment) connected to surge protection circuitry 120. The circuitry 120 protects electrical devices plugged into the receptacles 108/108a and 109/109a from electrical power surges in a conventional manner.

When the electrical connector 106/106a is plugged into the receptacle 109/109a, AC electrical power is provided to a converter 121 in the USB hub 100/110a. The converter generates lower voltage DC power to USB circuitry 122 that is connected to the USB connectors 104/104a. Thus, the USB hub 100/100a receives AC power and surge protection from the outlet strip 110/110a. For example, the converter 121 changes 110 Volt AC line current to 5 Volt DC power for the USB circuits 122. The USB hubs 100/100a receive AC power from the wall outlet and surge protection either internally within its own power circuitry in the housing or externally provided with the connected peripheral device(s). For example, the converter 121 changes 110 Volt AC line current to 5 Volt DC power for the USB circuits 122.

Referring now to FIGS. 9a-d, the USB hubs 100 and 100a may also be provided with interchangeable male connectors, such as conventional connectors used in Europe, the United Kingdom, Australia and the United States of America. The housing 102 and 102a is preferably provided with an opening 124 for receiving a male connector 126 corresponding to the conventional connector for a geographic location. The opening 124 is preferably provided with a locking mechanism 128 for securing and releasing the male connector 126 to the housing 102 and 102a. The opening 124 and male connector 126 are also provided with corresponding electrical connection means for transferring power from a wall outlet 130 to the USB hubs 100 and 100a. The housing 102 and 102a has a plurality of apertures formed therein each of which has conventional female USB connectors 104/104a mounted therein. When the hubs 100 and 100a are plugged into the wall outlet 130, AC electrical power is provided to a converter 121 in the USB hub 100/100a. The converter generates lower voltage DC power to USB circuitry 122 (FIG. 8) that is connected to the USB connectors 104/104a. Thus, the USB hubs 100/100a receive AC power from the wall outlet and surge protection either internally within its own power circuitry in the housing or externally provided with the connected peripheral device(s). For example, the converter 121 changes 110 Volt AC line current to 5 Volt DC power for the USB circuits 122.

To use, the appropriate male connector 126 is inserted into the opening 124 in the housing 102 and 102a. Once inserted, the male connector 126 turns clockwise into a locked position. The male connector 126 is then inserted into a wall outlet 130, either vertically or horizontally, exposing at least one USB connector 104/104a for use.

The USB hubs 100 and 100a in accordance with the present invention can be used with other outlet strips that may require elimination of the wings 103/103a. The USB hubs 100 and 100a in accordance with the present invention can also be connected directly to a wall outlet as shown in FIG. 9c.

The USB hubs 100 and 100a in accordance with the present invention advantageously provide a USB hub that may be located remotely from a user's desk, thereby freeing up desk space. The USB hubs 100 and 100a with the outlet strips 110 and 110a, respectively, also provide direct surge protection for data on any associated USB device connected thereto and may be designed to blend in with the styling of the outlet strip thereby providing a uniform and aesthetically pleasing appearance to a connected USB hub and outlet strip.

In addition, while the hubs 100/100a in accordance with the present invention have been described in the context of USB connectors, those skilled in the art will appreciate that other types of connectors including, but not limited to, Firewire® connectors or the like may be utilized while remaining within the scope of the present invention.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A USB hub comprising:
a housing;
at least one USB connector mounted within said housing;
at least one male electrical connector extending from said housing; and
a power converter connected between said at least one USB connector and said at least one male electrical connector, whereby said male electrical connector may be releasably attached to a source of electrical power for providing power to said at least one USB port.

2. The USB hub according to claim 1 wherein said at least one male electrical connector is releasably attached to said housing.

3. The USB hub according to claim 2 wherein said at least one male electrical connector is interchangeable with a second male electrical connector.

4. The USB hub according to claim 1 wherein said at least one male electrical connector is plugged in to an outlet having surge protection, whereby said USB hub receives AC power and surge protection from the outlet.

5. The USB hub according to claim 1 wherein said housing includes USB circuitry connected between said converter and said USB connectors.

6. The USB hub according to claim 3 including an outlet strip having a receptacle receiving said male electrical connector.

7. The USB hub according to claim 6 wherein said outlet strip includes a surge protection circuit connected to said receptacle.

8. The USB hub according to claim 7 wherein said male electrical connector is plugged in to said outlet strip, whereby said USB hub receives AC power and surge protection from said power surge protection circuit.

9. The USB hub according to claim 1 wherein said housing includes power surge protection circuitry.

10. A USB hub comprising:
a housing;
at least one USB connector mounted within said housing;
a first detachable male electrical connector extending from said housing; and
a power converter connected between said at least one USB connector and said at least one male electrical connector, wherein said first male electrical connector may be removed from said housing and replaced with a second male electrical connector and wherein said first or second male electrical connector may be releasably attached to a source of electrical power for providing power to said at least one USB port.

11. The USB hub according to claim 10 wherein said at least one male electrical connector is plugged in to an outlet having surge protection, whereby said USB hub receives AC power and surge protection from the outlet.

12. The USB hub according to claim 10 wherein said housing includes USB circuitry connected between said converter and said USB connectors.

13. The USB hub according to claim 10 including an outlet strip having a receptacle receiving said male electrical connector.

14. The USB hub according to claim 13 wherein said outlet strip includes a surge protection circuit connected to said receptacle.

15. The USB hub according to claim 14 wherein said male electrical connector is plugged in to said outlet strip, whereby said USB hub receives AC power and surge protection from said power surge protection circuit.

16. The USB hub according to claim 10 wherein said housing includes power surge protection circuitry.

17. A USB hub comprising:
a housing comprising power surge protection circuitry;
at least one USB connector mounted within said housing;
a first detachable male electrical connector extending from said housing; and
a power converter connected between said at least one USB connector and said at least one male electrical connector, wherein said first male electrical connector may be removed from said housing and replaced with a second male electrical connector and wherein said first or second male electrical connector may be releasably attached to a source of electrical power for providing power to said at least one USB port.

18. The USB hub according to claim 17 wherein said male electrical connector is plugged in to a wall outlet, whereby said USB hub receives AC power from said wall outlet and surge protection from said power surge protection circuit.

19. The USB hub according to claim 17 including an outlet strip having a receptacle receiving said male electrical connector, wherein said male electrical connector is plugged in to said outlet strip, whereby said USB hub receives AC power from said outlet strip and surge protection from said power surge protection circuit.

20. The USB hub according to claim 17 including an outlet strip having a receptacle receiving said male electrical connector, wherein said male electrical connector is plugged in to said outlet strip, whereby said USB hub receives AC power and surge protection from said from said outlet strip.
